(19) United States
(12) Patent Application Publication
(10) Pub. No.: US 2024/0289141 A1
(43) Pub. Date: Aug. 29, 2024

(54) RESOURCE PLAYING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Yiying WU, Beijing (CN); Hui SUN, Beijing (CN); Daoyu WANG, Beijing (CN); Lujia SHEN, Beijing (CN); Zheng WANG, Beijing (CN); Yixuan YANG, Beijing (CN); Hao GONG, Beijing (CN)

(21) Appl. No.: 18/572,461

(22) PCT Filed: Jul. 22, 2022
(86) PCT No.: PCT/CN2022/107309

§ 371 Date: Dec. 20, 2023

(30) Foreign Application Priority Data
Jul. 29, 2021 (CN) 202110862278.X

(51) Int. Cl. G06F 9/445; G06F 40/205; G11B 27/031

(52) U.S. Cl. CPC G06F 9/44505; G06F 40/205; G11B 27/031

(57) ABSTRACT

The disclosure provides a resource playing method, an apparatus, an electronic device, and a storage medium. The method includes: in response to a triggering for a first draft resource identification, displaying a first draft resource on a playing interface; and switching the first draft resource to a second draft resource on the playing interface in response to a first preset triggering on the playing interface. The first draft resource and the second draft resource are acquired based on resource files, code files, and configuration files which are stored.

### CROSS REFERENCE TO RELATED APPLICATIONS

This disclosure claims the priority of the Chinese Patent Application filed to the China Patent Office on Jul. 29, 2021, with the application number 202110862278.X and the title of “Resource playing method, apparatus, electronic device, and storage medium”, the entire disclosures of which are incorporated by reference as part of the disclosure of this application.

### TECHNICAL FIELD

The disclosure relates to the field of information technology, in particular to a resource playing method, an apparatus, an electronic device, and a storage medium.

### BACKGROUND

With the rapid development of terminal technology and network technology, the current video applications usually have functions like posting works and so on. By using video applications, users may create to post stand-out videos, or record their daily lives and post the videos they filmed casually in their lives.

When posting videos, users usually save multiple drafts of videos and then choose the one with better effect to post.

However, in the current technology, if there are multiple drafts of videos in the drafts folder, the user clicks on the cover of a certain video draft to enter the playing page, but only this video draft can be played. If the user wants to preview other drafts of videos, it is necessary to leave the current playing page first, and then click on the cover of other drafts of videos to enter the playing page of other video draft, and thus continuous playing of all video drafts cannot be realized. Therefore, it is not conducive for users to quickly preview or screen the video drafts.

### SUMMARY

In order to solve the above technical problems or at least partially solve the above technical problems, the embodiments of the present disclosure provide a resource playing method, an apparatus, an electronic device, and a storage medium, which realizes fast switching for playing of a plurality of draft resources, improves the switching efficiency of draft resources, simplifies the operation path when a user previews a plurality of draft resources, and is beneficial to improving the convenience and efficiency of screening draft resources by the user.

In the first aspect, the embodiments of the present disclosure provide a resource playing method, and the method comprises:
entering a playing page to play a first draft resource on the playing page in response to a trigger operation for a first draft resource identification; and
switching the first draft resource to a second draft resource on the playing page for playing in response to a first preset operation acting on the playing page,
wherein the first draft resource and the second draft resource are acquired based on resource files, code files, and configuration files stored by a video application.

In the second aspect, the embodiments of the present disclosure further provide a resource playing apparatus, which is integrated with a display terminal, and the apparatus comprises:
a playing module, configure to enter a playing page to play a first draft resource on the playing page in response to a trigger operation for a first draft resource identification; and
a playing switching module, configured to switch the first draft resource to a second draft resource on the playing page for playing in response to a first preset operation acting on the playing page,
wherein the first draft resource and the second draft resource are acquired based on resource files, code files, and configuration files stored by a video application.

In the third aspect, the embodiments of the present disclosure further provide an electronic device, and the electronic device comprises:
one or more processors; and
a storage apparatus for storing one or more programs,
wherein the one or more programs, when executed by the one or more processors, cause the one or more processors to realize the resource playing method as described above.

In the fourth aspect, the embodiments of the present disclosure further provide a computer-readable storage medium, and computer programs are stored thereon. When executed by a processor, the programs realize the resource playing method as described above.

### BRIEF DESCRIPTION OF DRAWINGS

The above and other features, advantages, and aspects of embodiments of the present disclosure will become more apparent by referring to the following detailed implementations taken in conjunction with the accompanying drawings. Throughout the drawings, the same or similar reference numerals indicate the same or similar elements. It should be understood that the drawings are schematic, and the components and elements are not necessarily drawn to scale.

FIG. 1 is a flowchart of a resource playing method in the embodiments of the present disclosure;

FIG. 2 is a flowchart of a resource playing method in the embodiments of the present disclosure;

FIG. 3 is a flowchart of a resource playing method in the embodiments of the present disclosure;

FIG. 4 is a flowchart of a resource playing method in the embodiments of the present disclosure;

FIG. 5 is a schematic structural diagram of a resource playing apparatus in the embodiments of the present disclosure; and

FIG. 6 is a schematic structural diagram of an electronic device in the embodiments of the present disclosure.

### DETAILED DESCRIPTION

Embodiments of the present disclosure will be described in more detail below with reference to the accompanying drawings. Although some embodiments of the present disclosure are illustrated in the drawings, it should be understood that the present disclosure can be embodied in various forms and should not be construed as limited to the embodiments set forth herein, but rather, these embodiments are provided for a more thorough and complete understanding of the present disclosure. It should be understood that the drawings and embodiments of the present disclosure are only used for exemplary functions, and are not used for limiting the protection scope of the present disclosure.

It should be understood that the steps described in the method implementations of the present disclosure can be performed in different orders and in parallel. Furthermore, the method implementations may include additional steps and/or omit to perform the illustrated steps. The scope of the present disclosure is not limited in this respect.

As used herein, the term “comprising” and its variants are open-ended comprising, that is, “comprising but not limited to”. The term “based on” is “at least partially based on”. The term “an embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in this disclosure are only used for distinguishing different apparatus, modules, or units, and are not used for limiting the order or interdependence of the functions performed by these apparatus, modules, or units.

It should be noted that the modifications of “one” and “a plurality of” mentioned in this disclosure are schematic rather than limiting, and those skilled in the art should understand that unless the context clearly indicates otherwise, they should be understood as “one or more”.

Names of messages or information exchanged among multiple apparatus in the implementations of the present disclosure are only used for illustrative purposes and are not used for limiting the scope of these messages or information.

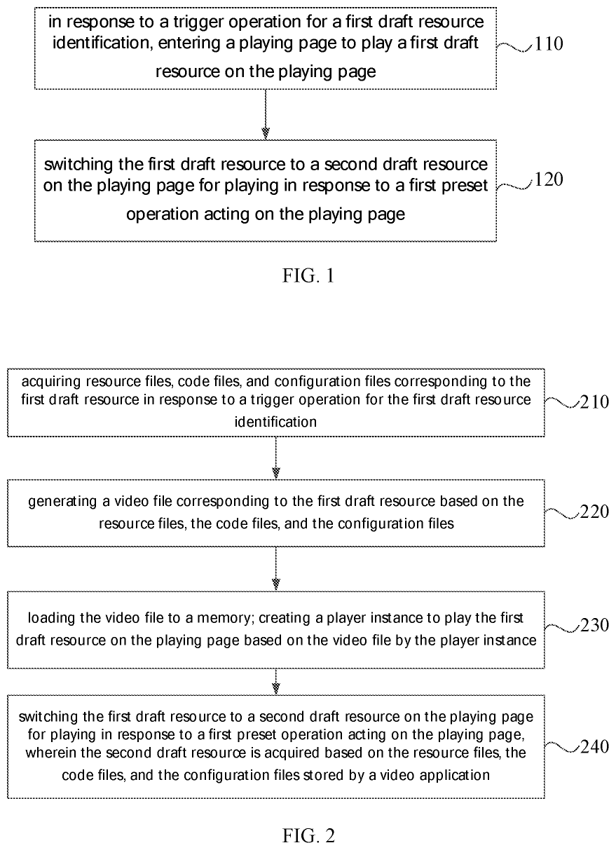

FIG. 1 is a flowchart of a resource playing method in the embodiments of the present disclosure. The method can be executed by a resource playing apparatus, which can be implemented by software and/or hardware, the apparatus can be configured in electronic devices, for example, display terminals, including but not limited to electronic devices with display screens such as smartphones, palmtop computers, tablet computers, portable wearable devices, smart home devices (such as desk lamps) and so on.

As shown in FIG. 1, the method can specifically include the following steps.

Step 110, entering a playing page to play a first draft resource on the playing page in response to a trigger operation for a first draft resource identification.

The first draft resource may be a video clip stored in the drafts folder of the video applications. The first draft resource identification may specifically be the cover of the video clip. In other words, the first draft resource refers to the video draft which is not post as works, which can only be viewed by the user himself/herself and cannot be viewed by other users. Videos post as works can be viewed by other users. The trigger operation may be a click operation, specifically, when the user clicks the first draft resource identification, the playing page can be entered and the first draft resource can be played on the playing page.

Step 120, switching the first draft resource to a second draft resource on the playing page for playing in response to a first preset operation acting on the playing page.

The first preset operation may be a swipe-up operation or a swipe-down operation. For example, when the user swipes up the playing page, the first draft resource being played is switched to the second draft resource on the playing page, that is, the second draft resource is played. In other words, the user may preview the second draft resource only by performing interactive operation based on the playing page, without exiting the playing page and entering the playing page where the second draft resource is played by triggering the second draft resource identification, so as to realize the preview of the second draft resource. Therefore, the scheme of this embodiment can simplify the operation path of switching draft resources, realize quick browsing and switching of multiple draft resources, simplify the operation path when users preview multiple draft resources, and facilitate to improvement of the convenience and efficiency of user screening draft resources.

It should be further explained that the files corresponding to the first draft resource and the second draft resource in this embodiment are not a complete video format file, and the first draft resource and the second draft resource are acquired based on resource files, code files, and configuration files stored by video applications; the resource files, the code files, and the configuration files are stored independently of each other and are not merged into the same file stored as a complete file that can be directly played. The resource files refer to files storing multimedia data (such as video data, audio data, animation data, etc.). The code files may specifically refer to files storing lua codes, and some draft resources are stored in the form of lua codes, for example, stickers (a type of special effect for editing) added to videos are stored in the form of lua codes. The configuration files refer to files that store descriptive information (such as the added position of a sticker in the video, the type of algorithm applied to the special effect added to the video, etc.). Therefore, in order to play the first draft resource or the second draft resource, it is first necessary to produce playable resource data based on the resource files, the code files, and the configuration files, and then the playable resource data is played. For example, according to the added position of the sticker in the video indicated in the descriptive information in the configuration files, playable data corresponding to the sticker is added to the video data corresponding to the added position to produce playable resource data with the special effect of the sticker.

The resource playing method provided by this embodiment realizes the purpose of fast switching and browsing at least two draft resources; specifically, a playing page is entered and a first draft resource is played on the playing page in response to a trigger operation for the first draft resource identification, and the first draft resource is switched to a second draft resource on the playing page for playing in response to a first preset operation acting on the playing page, that is, by triggering the first preset operation on the playing page, the second draft resource can be played without exiting the playing page and then by triggering the second draft resource identification to enter the playing page for playing the second draft resource. The continuous playing of multiple draft resources is realized, the playing efficiency of the draft resources is improved, the operation path for the user when previewing multiple draft resources is simplified, and the convenience and efficiency of screening the draft resources by the user are facilitate to be improved.

On the basis of the above embodiments, referring to the flowchart of a resource playing method as illustrated in FIG. 2, this embodiment provides an alternative implementation for the above step 110 of “entering a playing page to play a first draft resource on the playing page in response to a trigger operation for a first draft resource identification.” As illustrated in FIG. 2, the method comprises following steps.

Step 210, acquiring resource files, code files, and configuration files corresponding to the first draft resource in response to a trigger operation for the first draft resource identification.

Step 220, generating a video file corresponding to the first draft resource based on the resource files, the code files, and the configuration files.

The resource files refer to files storing multimedia data (such as video data, audio data, animation data, etc.), which can be directly read by the player instance. The code files refer to files storing some codes, such codes may be lua code, which is a scripting language. Some draft resources are stored in the form of lua code, for example, some special effects (such as stickers, etc.) added to the video are stored in the form of lua code, which cannot be directly read and played by the player instance. Therefore, in order to play special effects, it is necessary to process the code files in advance to convert the stored codes into data that can be read and played by the player instance. The configuration files refer to files storing descriptive information (for example, information describing the added position of a special effect in the video, the type of algorithm applied to the special effect added to the video, etc.), and this kind of information cannot be directly read by the player instance, so it is necessary to process this kind of file in advance to convert the stored information into data that can be read and played by the player instance.

Specifically, generating a video file corresponding to the first draft resource based on the resource files, the code files, and the configuration files comprises: performing format conversion of the codes in the code files, so as to convert the codes into data that can be read and played by a player instance, and adding the data converted based on the codes stored in the code files to an appropriate position of the resource files according to descriptive information in the configuration files, so as to generate a video file corresponding to the first draft resource.

Step 230, loading the video file to a memory; and creating a player instance to realize playing the first draft resource on the playing page based on the video file by the player instance.

Specifically, the player instance acquires the data in the video file from the memory, and plays the data, so as to implement playing the first draft resource.

Step 240, switching the first draft resource to a second draft resource on the playing page for playing in response to a first preset operation acting on the playing page, where the second draft resource is acquired based on the resource files, the code files, and the configuration files stored by a video application.

In this embodiment, a video file that can be played directly is produced in advance based on the resource files, the code files, and the configuration files corresponding to the first draft resource, and then the video file is played by the player instance, so as to implement playing the first draft resource.

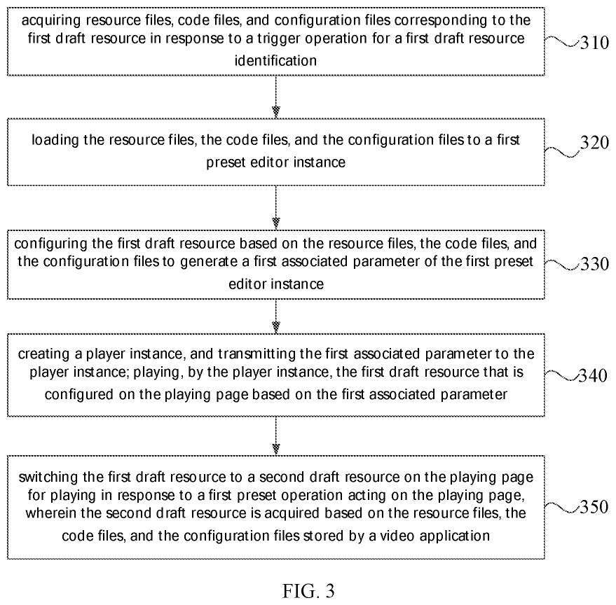

In another embodiment, referring to the flowchart of a resource playing method as illustrated in FIG. 3, this embodiment provides another alternative embodiment for the above step 110 of “entering a playing page to play a first draft resource on the playing page in response to a trigger operation for a first draft resource identification.” As illustrated in FIG. 3, the method comprises following steps.

Step 310, acquiring resource files, code files, and configuration files corresponding to a first draft resource in response to a trigger operation for a first draft resource identification.

Step 320, loading the resource files, the code files, and the configuration files to a first preset editor instance.

The resource files are files storing multimedia data and such files can also be directly read by the first preset editor instance. However, the data stored in the code files and the configuration files cannot be directly read by the first preset editor instance, so it is necessary to perform format conversion on the data in the code files and the configuration files. Particularly, loading the code files and the configuration files to the first preset editor instance comprises: parsing the code files and the configuration files and transforming data structure, respectively, so as to obtain target data suitable for the first preset editor instance, and loading the target data to the memory; acquiring the target data from the memory based on the first preset editor instance.

Step 330, configuring the first draft resource based on the resource files, the code files, and the configuration files, so as to generate a first associated parameter of the first preset editor instance.

The purpose of loading the resource files, code files, and configuration files to the first preset editor instance is in the first preset editor instance, adding the code in the code files to the appropriate position of the resource files to produce video data that can be played according to the descriptive information in the configuration files, and configuring the used related algorithm interfaces, such as the filter algorithm interface used for the added filter special effect, so as to take the video data and the related algorithm interface as the first related parameters of the first preset editor instance.

Illustratively, the resource files include video resource files and special effect resource files, and the special effect resource files and the video resource files are stored independently of each other. Playing the first draft resource on the playing page comprises: playing an original video and the special effects added to the original video. The original video refers to the video filmed by a shooting device (such as a camera) without editing. Special effects refer to the contents added to the original video when editing the original video after the original video is shot, such as voice-changing audio special effects and the like. The multimedia special effects resources such as voice-changing audio and so on are stored in the special effects resource files, the added position of the special effects of voice-changing audio in the original video is stored in the configuration files in the form of descriptive information, and the original video is stored in the video resource files. In the first preset editor instance, according to the descriptive information in the configuration files, the data in the special effects resource files is added to the appropriate position of the video resource files, and the related algorithm interfaces are configured, to produce the first associated parameter of the first preset editor instance, so as to achieve the purpose of restoring the special effects added in the original video.

Step 340, creating a player instance, and transmitting the first associated parameter to the player instance; playing, by the player instance, the first draft resource that is configured on the playing page based on the first associated parameter.

Step 350, switching the first draft resource to a second draft resource on the playing page for playing in response to a first preset operation acting on the playing page, where the second draft resource is acquired based on the resource files, the code files, and the configuration files stored by a video application, and the method for playing the second draft resource is similar to that of the first draft resource, so the details are not repeated here.

In this embodiment, the resource files, the code files, and the configuration files stored independently are loaded to the first preset editor instance, the first draft resource is configured in the first preset editor instance, and the contents related to configuration items are taken as the first associated parameter of the first preset editor instance, and then the first associated parameter is transmitted to the player instance, and the first draft resource is played by the player instance.

It can be understood that for the first preset editor instance, an initialization operation is needed to configure some interfaces, functional functions, and the like required by the first preset editor instance. Therefore, in one implementation, before loading the resource files, the code files, and the configuration files to the first preset editor instance, the method further comprises: loading the first preset editor instance to a memory and initializing the first preset editor instance. It can be understood that it takes a certain time to initialize the first preset editor instance, thus, in order to improve the efficiency of playing the first draft resource and reduce the waiting time of users, in one implementation, the first preset editor instance is initialized in advance, and the initialized first preset editor instance is stored in an instance pool in the memory, and when the first preset editor instance is needed, the first preset editor instance is acquired from the instance pool in the memory, where the instance pool includes at least two initialized preset editor instances.

On the same principle, it needs to be implemented by a second preset editor instance when playing the second draft resource, and in order to reduce the waiting time of users, in one embodiment, at least one second preset editor instance is acquired and in the meanwhile, the first preset editor instance is acquired, and the sequence relationship between the at least one second preset editor instance and the first preset editor instance is set. For example, when acquiring the first preset editor instance, two second preset editor instances, respectively are the second preset editor instance a and the second preset editor instance b, are acquired, and the second preset editor instance a and the first preset editor instance are set in an adjacent order relationship, and the second preset editor instance b and the second preset editor instance a are in an adjacent order relationship.

For example, the drafts folder includes a first draft resource, a second draft resource, and a third draft resource which are arranged in sequence, and they are played by the first preset editor instance, the second preset editor instance a, and the second preset editor instance b, respectively. In particular, when receiving a first preset operation triggered by the user on the playing page (currently playing the first draft resource on the playing page), the second draft resource is played by the second preset editor instance a and the player instance; when playing the second draft resource, if a first preset operation triggered by the user on the playing page is received again, the third draft resource is played by the second preset editor instance b and the player instance.

Specifically, switching the first draft resource to a second draft resource on the playing page for playing in response to the first preset operation on the playing page comprises: loading the resource files, code files, and configuration files corresponding to the second draft resource to one second preset editor instance, and configuring the second draft resource based on the resource files, code files, and configuration files corresponding to the second draft resource to produce the second associated parameter of the second preset editor instance; transmitting the second associated parameter to the player instance; playing, by the player instance, the configured second draft resource on the playing page based on the second associated parameter.

Further, when the first draft resource is switched to the second draft resource on the playing page, there is a temporary black screen due to the latency problem, and in order to alleviate this problem and improve the preview experience of users, before switching the first draft resource to the second draft resource for playing on the playing page, the method further comprises: displaying a preset picture on the playing page in response to a first preset operation acting on the playing page. The preset picture includes a predetermined frame image of the second draft resource. That is, when the first preset operation triggered by the user is received, the predetermined image is displayed first, and when processing of the data corresponding to the second draft resource is completed in the background, i.e., the second draft resource can be played, and then the interface displaying the predetermined frame image is switched to the playing interface, so that the purpose of improving the preview experience of the user can be achieved. The predetermined frame image may be a cover image of the second draft resource.

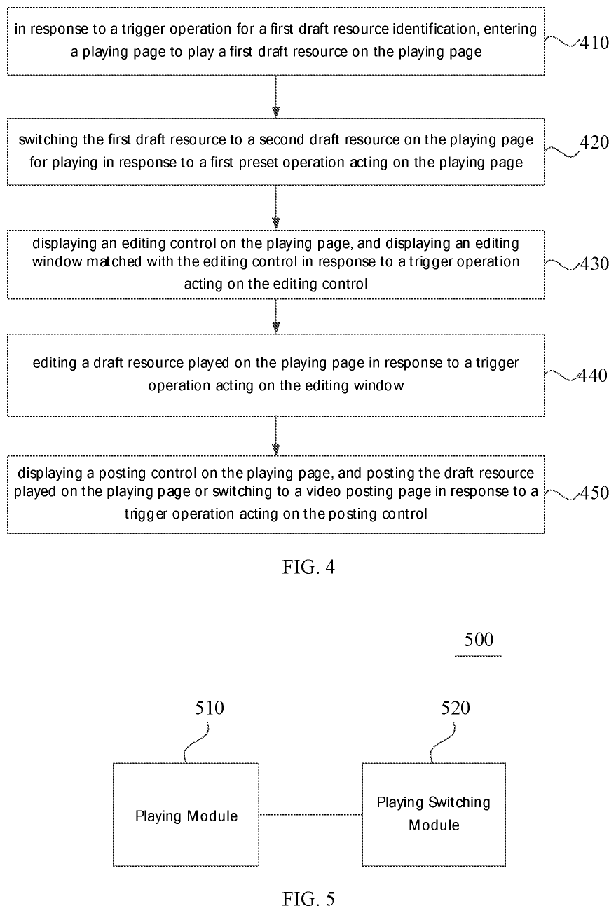

On the basis of the above-mentioned embodiments, because the resource files, the code files, and the configuration files corresponding to each draft resource are separately stored, instead of being integrated into one file, the editing function is also supported for each draft resource, that is, during the process of playing the draft resources, the user can continue editing the draft resources, such as adding special effects like stickers and filters, and so on. Specifically, referring to the flow diagram of a resource playing method illustrated in FIG. 4, the method comprises the following steps.

Step 410, entering a playing page to play a first draft resource on the playing page in response to a trigger operation for a first draft resource identification.

Step 420: switching the first draft resource to a second draft resource on the playing page for playing in response to a first preset operation acting on the playing page.

The first draft resource and the second draft resource are acquired based on resource files, code files, and configuration files stored by a video application.

Step 430, displaying an editing control on the playing page, and displaying an editing window matched with the editing control in response to a trigger operation on the editing control.

Step 440, editing the draft resource played on the playing page in response to a trigger operation acting on the editing window.

Step 450, displaying a posting control on the playing page, and posting the draft resource played on the playing page or switching to a video posting page in response to a trigger operation acting on the posting control.

FIG. 5 is a schematic structural diagram of a resource playing apparatus in the embodiments of the present disclosure. As illustrated in FIG. 5, the resource playing apparatus 500 specifically includes a playing module 510 and a playing switching module 520.

The playing module 510 is used for entering a playing page to play the first draft resource on the playing page in response to a trigger operation for the first draft resource identification; the playing switching module 520 is used for switching the first draft resource to a second draft resource on the playing page for playing in response to a first preset operation acting on the playing page. The first draft resource and the second draft resource are acquired based on resource files, code files, and configuration files stored by a video application.

Alternatively, the playing module 510 includes: a first acquiring unit, used for acquiring the resource files, the code files, and the configuration files corresponding to the first draft resource in response to a trigger operation for the first draft resource identification; a producing unit, used for generating a video file corresponding to the first draft resource based on the resource files, the code files, and the configuration files; a first loading unit, used for loading the video file to a memory; a first creating unit, used for creating a player instance; and a first playing unit, used for playing the first draft resource on the playing page based on the video file by the player instance.

Alternatively, the playing module 510 includes: a second acquiring unit, used for acquiring the resource files, the code files, and the configuration files corresponding to the first draft resource in response to a trigger operation for the first draft resource identification; a second loading unit, used for loading the resource files, the code files, and the configuration files to a first preset editor instance; a first configuration unit, used for configuring the first draft resource based on the resource files, the code files, and the configuration files to generate a first associated parameter of the first preset editor instance; a second creating unit, used for creating a player instance; a first transmitting unit, used for transmitting the first associated parameter to the player instance; and a second playing unit, used for playing the configured first draft resource on the playing page based on the first associated parameter by the player instance.

Alternatively, the playing module 510 further comprises: an initialization unit, used for loading the first preset editor instance to a memory and initializing the first preset editor instance before loading the resource files, the code files, and the configuration files to the first preset editor instance; or, acquiring the first preset editor instance from an instance pool in the memory, and the instance pool including at least two initialized preset editor instances.

Alternatively, the initialization unit is further used for acquiring at least one second preset editor instance when acquiring the first preset editor instance, and setting the sequence relationship between the at least one second preset editor instance and the first preset editor instance.

Alternatively, the playing switching module 520 comprises: a third loading unit, used for loading the resource files, the code files, and the configuration files corresponding to the second draft resource to one second preset editor instance; a second configuration unit, used for configuring the second draft resource based on the resource files, the code files, and the configuration files corresponding to the second draft resource to generate a second associated parameter of the second preset editor instance; a second transmitting unit, used for transmitting the second associated parameter to the player instance; and a third playing unit, used for playing the configured second draft resource on the playing page based on the second associated parameter by the player instance.

Alternatively, the playing switching module 520 further comprises a display unit, which is used for displaying a preset picture on a playing page in response to a first preset operation acting on the playing page. The preset picture includes a predetermined frame image of the second draft resource.

Alternatively, the resource files include video resource files and special effect resource files, and the special effect resource files and the video resource files are stored independently of each other. The playing module 510 is further used for playing the special effects added to the first draft resource.

Alternatively, the second loading unit comprises: a processing sub-unit, used for parsing the configuration files and the code files corresponding to the special effects and converting the data structure, respectively, so as to obtain target data adapted to the first preset editor instance, and loading the target data to a memory; an acquiring sub-unit, used for acquiring the target data from the memory based on the first preset editor instance.

Alternatively, the apparatus further comprises: a display module, used for displaying an editing window matched with the editing control in response to a trigger operation acting on the editing control, and the editing control being displayed on the playing page; a processing module, used for editing the draft resource played on the playing page in response to a trigger operation acting on the editing window.

Alternatively, the apparatus further comprises a posting module, which is used for posting the draft resource played on the playing page or switching to a video posting page in response to a trigger operation acting on a posting control. The posting control is displayed on the playing page.

The resource playing apparatus provided by the embodiments of the present disclosure achieves the purpose of continuously playing at least two draft resources on the same playing page. Specifically, a playing page is entered and a first draft resource is displayed on the playing page in response to a trigger operation for a first draft resource identification, and the first draft resource is switched to a second draft resource on the playing page for playing in response to a first preset operation acting on the playing page, that is, by triggering the first preset operation on the playing page, the second draft resource can be played without exiting the playing page and entering the playing page for playing the second draft resource by triggering the second draft resource identification, which simplifies the operation path when the user previews multiple draft resources and is beneficial to improving the convenience and efficiency of user screening draft resources.

The resource playing apparatus provided by the embodiments of the present disclosure can execute the steps in the resource playing method provided by the embodiments of the present disclosure, and the execution steps and beneficial effects are not repeated here.

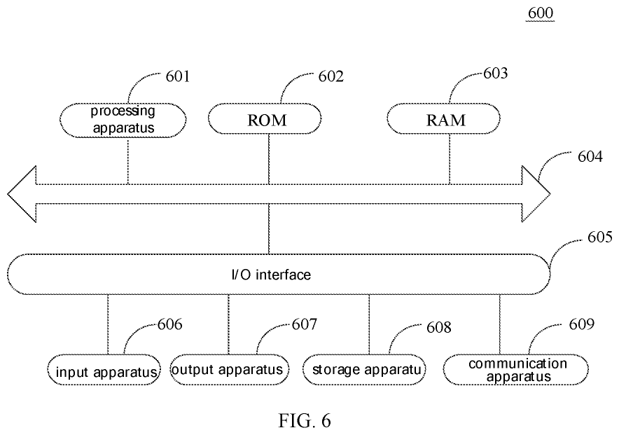

FIG. 6 is a schematic structural diagram of an electronic device in an embodiment of the present disclosure. Referring to FIG. 6, it illustrates a structural schematic diagram suitable for implementing an electronic device 600 in the embodiments of the present disclosure. The electronic device 600 in the embodiments of the present disclosure may include but is not limited to, mobile terminals such as mobile phones, notebook computers, digital broadcast receivers, personal digital assistant (PDA), tablet computer (PAD), portable multimedia player (PMP), vehicle-mounted terminals (such as vehicle-mounted navigation terminals), wearable electronic devices and the like, and fixed terminals such as digital TV, desktop computers, smart home devices and the like. The electronic device illustrated in FIG. 6 is just an example, and should not bring any limitation to the function and application scope of the embodiments of the present disclosure.

As illustrated in FIG. 6, the electronic device 600 may include a processing apparatus (e.g., a central processing unit, a graphics processor, etc.) 601, which may perform various appropriate actions and processes according to a program stored in a read-only memory (ROM) 602 or a program loaded from a storage apparatus 608 to a random access memory (RAM) 603 to realize the method according to the embodiments of the present disclosure. In the RAM 603, various programs and data required for the operation of the electronic device 600 are also stored. The processing apparatus 601, the ROM 602, and the RAM 603 are connected to each other by a bus 604. An input/output (I/O) interface 605 is also connected to the bus 604.

Generally, the following apparatus may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 illustrates an electronic device 600 with various apparatus, it should be understood that it is not required to implement or have all the apparatuses shown, more or fewer apparatus may alternatively be implemented or provided.

In particular, according to the embodiments of the present disclosure, the process described above with reference to the flowchart may be implemented as a computer software program. For example, the embodiments of the present disclosure include a computer program product including a computer program carried on a non-transitory computer-readable medium, which contains program code for executing the method shown in the flowchart, thereby realizing the method as described above. In such an embodiment, the computer program can be downloaded and installed from the network by the communication apparatus 609, or installed from the storage apparatus 608, or installed from the ROM 602. When the computer program is executed by the processing apparatus 601, the above functions defined in the method of the embodiments of the present disclosure are performed.

It should be noted that the computer-readable medium mentioned above in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. More specific examples of computer-readable storage media may include but are not limited to, an electrical connection with one or more wires, a portable computer disk, a hard disk, a random access memory (RAM), a read-only memory (ROM), a erasable programmable read-only memory (EPROM or flash memory), an optical fiber, a portable compact disk read-only memory (CD-ROM), an optical storage device, a magnetic storage device, or any suitable combination of the above. In this disclosure, the computer-readable storage medium may be any tangible medium containing or storing a program, which can be used by or in combination with an instruction execution system, apparatus, or device. In this disclosure, the computer-readable signal medium may include a data signal propagated in a baseband or as part of a carrier wave, in which computer-readable program codes are carried. This propagated data signal can take many forms, including but not limited to electromagnetic signals, optical signals, or any suitable combination of the above. The computer-readable signal medium can also be any computer-readable medium other than a computer-readable storage medium, which can send, propagate, or transmit a program for use by or in connection with an instruction execution system, apparatus, or device. The program code contained in the computer-readable medium may be transmitted through any suitable medium, including but not limited to wires, optical cables, radio frequency (RF), and the like, or any suitable combination of the above.

In some embodiments, the client and the server can communicate by using any currently known or future-developed network protocol such as HyperText transfer protocol (HTTP) and can be interconnected with digital data communication in any form or medium (for example, communication network). Examples of communication networks include a local area network (LAN), a wide area network (WAN), Internetworking (for example, the Internet), and end-to-end networks (for example, ad hoc end-to-end networks), as well as any currently known or future-developed networks.

The computer-readable medium may be included in the electronic device, and it may exist alone without being assembled into the electronic device.

The computer-readable medium carries one or more programs that, when executed by the electronic device, cause the electronic device to:

entering a playing page to play a first draft resource on the playing page in response to a trigger operation for a first draft resource identification; switching the first draft resource to a second draft resource on the playing page for playing in response to a first preset operation acting on the playing page. The first draft resource and the second draft resource are acquired based on resource files, code files, and configuration files stored by a video application.

Alternatively, when the above one or more programs are executed by the electronic device, the electronic device may also perform other steps described in the above embodiment.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer by any kind of network, including a local area network (LAN) or a wide area network (WAN), or may be connected to an external computer (for example, by the Internet using an Internet service provider).

The flowcharts and block diagrams in the drawings illustrate the architecture, functions, and operations of possible implementations of systems, methods, and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiments described in the present disclosure may be implemented by the manner of software and may also be implemented by the manner of hardware. Among them, the name of the unit does not constitute the limitation of the unit itself in some cases.

The functions described above herein may be at least partially performed by one or more hardware logic components. For example, without limitation, exemplary types of hardware logic components that can be used include field programmable gate array (FPGA), application specific integrated circuit (ASIC), application specific standard product (ASSP), system on chip (SOC), complex programmable logic device (CPLD), and so on.

In the context of this disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

According to one or more embodiments of the present disclosure, the present disclosure provides a resource playing method, which comprises: entering a playing page to play a first draft resource on the playing page in response to a trigger operation for a first draft resource identification; and switching the first draft resource to a second draft resource on the playing page for playing in response to a first preset operation acting on the playing page. The first draft resource and the second draft resource are acquired based on resource files, code files, and configuration files stored by a video application.

According to one or more embodiments of the present disclosure, in the resource playing method provided by the present disclosure, alternatively, entering a playing page to play a first draft resource on the playing page in response to a trigger operation for the first draft resource identification comprises: acquiring resource files, code files, and configuration files corresponding to the first draft resource in response to the trigger operation for the first draft resource identification; generating a video file corresponding to the first draft resource based on the resource files, the code files, and the configuration files; loading the video file to a memory; and creating a player instance to play the first draft resource on the playing page based on the video file by the player instance.

According to one or more embodiments of the present disclosure, in the resource playing method provided by the present disclosure, alternatively, entering a playing page to play the first draft resource on the playing page in response to a trigger operation for a first draft resource identification comprises: acquiring resource files, code files, and configuration files corresponding to the first draft resource in response to the trigger operation for the first draft resource identification; loading the resource files, the code files, and the configuration files to a first preset editor instance; configuring the first draft resource based on the resource files, the code files, and the configuration files to generate a first associated parameter of the first preset editor instance; creating a player instance, and transmitting the first associated parameter to the player instance; playing, by the player instance, the configured first draft resource on the playing page based on the first associated parameter.

According to one or more embodiments of the present disclosure, in the resource playing method provided by the present disclosure, alternatively, before loading the resource files, the code files, and the configuration files to the first preset editor instance, the method further comprises: loading the first preset editor instance to a memory and initializing the first preset editor instance; or, acquiring the first preset editor instance from an instance pool in the memory, and the instance pool including at least two initialized preset editor instances.

According to one or more embodiments of the present disclosure, in the resource playing method provided by the present disclosure, alternatively, when acquiring the first preset editor instance, the method further comprises: acquiring at least one second preset editor instance and setting the sequence relationship between the at least one second preset editor instance and the first preset editor instance.

According to one or more embodiments of the present disclosure, in the resource playing method provided by the present disclosure, alternatively, switching the first draft resource to the second draft resource on the playing page for playing in response to the first preset operation acting on the playing page comprises: loading the resource files, the code files, and the configuration files corresponding to the second draft resource to the second preset editor instance; configuring the second draft resource based on the resource files, the code files, and the configuration files corresponding to the second draft resource to generate a second associated parameter of the second preset editor instance; transmitting the second association parameter to the player instance; playing, by the player instance, the configured second draft resource on the playing page based on the second associated parameter.

According to one or more embodiments of the present disclosure, in the resource playing method provided by the present disclosure, alternatively, before switching the first draft resource to a second draft resource on the playing page for playing, the method further comprises: displaying a preset picture on the playing page in response to a first preset operation acting on the playing page, where the preset picture includes a predetermined frame image of the second draft resource.

According to one or more embodiments of the present disclosure, in the resource playing method provided by the present disclosure, alternatively, the resource files include video resource files and special effects resource files, and playing the first draft resource on the playing page comprises: playing the original video and special effects added to the original video. The special effect resource files and the video resource files are stored independently of each other.

According to one or more embodiments of the present disclosure, in the resource playing method provided by the present disclosure, alternatively, loading the code files and the configuration files to a first preset editor instance comprises: parsing the code files and the configuration files and transforming data structure, respectively, so as to obtain target data adapted to the first preset editor instance, and loading the target data to a memory; acquiring the target data from memory based on the first preset editor instance.

According to one or more embodiments of the present disclosure, in the resource playing method provided by the present disclosure, alternatively, an editing control is displayed on the playing page, and the method further comprises: displaying an editing window matched with the editing control in response to a trigger operation acting on the editing control; editing the draft resource played on the playing page in response to a trigger operation acting on the editing window.

According to one or more embodiments of the present disclosure, in the resource playing method provided by the present disclosure, alternatively, a posting control is displayed on the playing page, and the method further comprises: posting the draft resources played on the playing page or switching to a video posting page in response to a trigger operation acting on the posting control.

According to one or more embodiments of the present disclosure, the present disclosure provides a resource playing apparatus, which comprises: a playing module, used for entering a playing page to play a first draft resource on the playing page in response to a trigger operation for a first draft resource identification; a playing switching module, used for switching the first draft resource to a second draft resource on the playing page for playing in response to a first preset operation acting on the playing page. The first draft resource and the second draft resource are acquired based on resource files, code files, and configuration files stored by a video application.

According to one or more embodiments of the present disclosure, in the resource playing apparatus provided by the present disclosure, alternatively, the playing module comprises: a first acquiring unit, used for acquiring the resource files, the code files, and the configuration files corresponding to the first draft resource in response to a trigger operation for a first draft resource identification; a producing unit, used for generating a video file corresponding to the first draft resource based on the resource files, the code files, and the configuration files; a first loading unit, used for loading the video file to a memory; a first creating unit, used for creating a player instance; and a first playing unit, used for playing the first draft resource on the playing page based on the video file by the player instance.

According to one or more embodiments of the present disclosure, in the resource playing apparatus provided by the present disclosure, alternatively, the playing module comprises: a second acquiring unit, used for acquiring the resource files, the code files, and the configuration files corresponding to the first draft resource in response to a trigger operation for the first draft resource identification; a second loading unit, used for loading the resource files, the code files, and the configuration files to a first preset editor instance; a first configuration unit, used for configuring the first draft resource based on the resource files, the code files, and the configuration files to generate a first associated parameter of the first preset editor instance; a second creating unit, used for creating a player instance; a first transmitting unit, used for transmitting the first associated parameter to the player instance; and a second playing unit, used for playing the configured first draft resource on the playing page based on the first associated parameter by the player instance.

According to one or more embodiments of the present disclosure, in the resource playing apparatus provided by the present disclosure, alternatively, the playing module further comprises: an initialization unit, used for loading the first preset editor instance to a memory and initializing the first preset editor instance before loading the resource files, the code files, and the configuration files to the first preset editor instance; or acquiring the first preset editor instance from an instance pool in the memory, and the instance pool including at least two initialized preset editor instances.

According to one or more embodiments of the present disclosure, in the resource playing apparatus provided by the present disclosure, alternatively, the initialization unit is further used for acquiring at least one second preset editor instance when acquiring the first preset editor instance and setting the sequence relationship between the at least one second preset editor instance and the first preset editor instance.

According to one or more embodiments of the present disclosure, in the resource playing apparatus provided by the present disclosure, alternatively, the playing switching module comprises: a third loading unit, used for loading the resource files, the code files, and the configuration files corresponding to the second draft resource to a second preset editor instance; a second configuration unit, used for configuring the second draft resource based on the resource files, the code files, and the configuration files corresponding to the second draft resource to generate a second associated parameter of the second preset editor instance; a second transmitting unit, used for transmitting the second associated parameter to the player instance; and a third playing unit, used for playing the configured second draft resource on the playing page based on the second associated parameter by the player instance.

According to one or more embodiments of the present disclosure, in the resource playing apparatus provided by the present disclosure, alternatively, the playing switching module further comprises a display unit which is used for displaying a preset picture on the playing page in response to a first preset operation acting on the playing page. The preset picture includes a predetermined frame image of the second draft resource.

According to one or more embodiments of the present disclosure, in the resource playing apparatus provided by the present disclosure, alternatively, the resource files include video resource files and special effect resource files, and the special effect resource files and the video resource files are stored independently of each other. The playing module 510 is further used for playing the special effect added to the first draft resource.

According to one or more embodiments of the present disclosure, in the resource playing apparatus provided by the present disclosure, alternatively, the second loading unit includes: a processing sub-unit, used for parsing the configuration files and the code files corresponding to the special effect and transforming data structure, respectively, so as to obtain target data adapted to the first preset editor instance, and loading the target data to a memory; and an acquiring sub-unit, used for acquiring the target data from the memory based on the first preset editor instance.

According to one or more embodiments of the present disclosure, in the resource playing apparatus provided by the present disclosure, alternatively, the apparatus further comprises: a display module, used for displaying an editing window matched with the editing control in response to a trigger operation acting on the editing control, where the editing control is displayed on the playing page; a processing module, used for editing the draft resource played on the playing page in response to the trigger operation acting on the editing window.

According to one or more embodiments of the present disclosure, in the resource playing apparatus provided by the present disclosure, alternatively, the apparatus further comprises: a posting module, used for posting the draft resource played on the playing page or switching to a video posting page in response to a trigger operation acting on a posting control. The posting control is displayed on the playing page.

According to one or more embodiments of the present disclosure, the present disclosure provides an electronic device, which comprises:
one or more processors; and
a memory for storing one or more programs.

The one or more programs, when executed by the one or more processors, cause the one or more processors to realize the resource playing method according to any embodiments provided by the present disclosure.

According to one or more embodiments of the present disclosure, the present disclosure provides a computer-readable storage medium, which stores computer program thereon. When executed by a processor, the computer program realizes the resource playing method provided by the present disclosure.

The embodiments of the present disclosure also provide a computer program product, which comprises computer programs or instructions, and the computer programs or instructions, when executed by a processor, realize the resource playing method as described above.

The above description is only the preferred embodiments of the present disclosure and the explanation of the applied technical principles. It should be understood by those skilled in the art that the disclosure scope involved in this disclosure is not limited to the technical scheme formed by the specific combination of the above technical features, but also contains other technical schemes formed by any combination of the above technical features or their equivalent features without departing from the above disclosure concept, such as technical schemes formed by replacing the above features with technical features having similar functions disclosed (but not limited to) in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A resource playing method, comprising:
in response to a triggering for a first draft resource identification, displaying a first draft resource on a playing interface; and
switching the first draft resource to a second draft resource on the playing interface in response to a first preset triggering on the playing interface,
wherein the first draft resource and the second draft resource are acquired based on resource files, code files, and configuration files which are stored.

2. The method of claim 1, wherein, in response to the triggering for the first draft resource identification, displaying the first draft resource on the playing interface, comprises:
acquiring the resource files, the code files, and the configuration files corresponding to the first draft resource in response to the triggering for the first draft resource identification;
generating a video file corresponding to the first draft resource based on the resource files, the code files, and the configuration files;
loading the video file to a memory; and
creating a player instance to play the first draft resource on the playing page interface based on the video file by the player instance.

3. The method of claim 1, wherein, in response to the triggering for the first draft resource identification, displaying the first draft resource on the playing interface, comprises:
acquiring the resource files, the code files, and the configuration files corresponding to the first draft resource in response to the triggering for the first draft resource identification;
loading the resource files, the code files, and the configuration files to a first preset editor instance;
based on the resource files, the code files, and the configuration files, configuring the first draft resource to generate a first associated parameter of the first preset editor instance;
creating a player instance, and transmitting the first associated parameter to the player instance; and
playing, by the player instance, the first draft resource that is configured on the playing interface based on the first associated parameter.

4. The method of claim 3, wherein before loading the resource files, the code files, and the configuration files to the first preset editor instance, the method further comprises:
loading the first preset editor instance to a memory, and initializing the first preset editor instance; or
acquiring the first preset editor instance from an instance pool in the memory, wherein the instance pool comprises at least two preset editor instances that are initialized.

5. The method of claim 4, wherein, while acquiring the first preset editor instance, the method further comprises:
acquiring at least one second preset editor instance, and setting the sequence relationship between the at least one second preset editor instance and the first preset editor instance.

6. The method of claim 5, switching the first draft resource to the second draft resource on the playing interface in response to the first preset triggering on the playing interface comprises:
loading the resource files, the code files, and the configuration files corresponding to the second draft resource to the second preset editor instance;
configuring the second draft resource based on the resource files, the code files, and the configuration files corresponding to the second draft resource, so as to generate a second associated parameter of the second preset editor instance;
transmitting the second association parameter to the player instance; and
playing, by the player instance, the second draft resource that is configured on the playing interface based on the second associated parameter.

7. The method of claim 6, wherein, before switching the first draft resource to the second draft resource on the playing interface, the method further comprises:
displaying a preset picture on the playing interface in response to the first preset triggering on the playing interface, wherein the preset picture comprises a predetermined frame image of the second draft resource.

8. The method of claim 3, wherein the resource files comprise video resource files and special effects resource files, and playing the first draft resource on the playing interface comprises:
playing an original video and special effects added in the original video,
wherein the original video is acquired through the video resource files, the special effects in the original video are acquired through the special effects resource files, and the special effect resource files and the video resource files are stored independently of each other.

9. The method of claim 3, wherein loading the code files and the configuration files to the first preset editor instance comprises:
parsing the code files and the configuration files and transforming data structures, respectively, so as to obtain target data adapted to the first preset editor instance, and loading the target data to a memory; and
acquiring the target data from memory based on the first preset editor instance.

10. The method of claim 1, wherein an edit control is displayed on the playing interface, and the method further comprises:
displaying an editing interface matched with the editing control in response to a triggering on the editing control; and
editing a draft resource played on the playing interface in response to a triggering on the editing interface.

11. The method of claim 1, wherein a posting control is displayed on the playing interface, and the method further comprises:
in response to a triggering on the posting control, posting a draft resource played on the playing interface or switching to a video posting interface.

12. A resource playing apparatus, comprising:
a playing module, configured to displaying a first draft resource on a playing interface in response to a triggering for a first draft resource identification; and
a playing switching module, configured to switch the first draft resource to a second draft resource on the playing interface in response to a first preset triggering on the playing interface,
wherein the first draft resource and the second draft resource are acquired based on resource files, code files, and configuration files which are stored.

13. An electronic device, comprising:
one or more processors; and
a storage apparatus for storing one or more programs,
wherein the one or more programs, when executed by the one or more processors, cause the one or more processors to implement the method of claim 1.

14. A computer-readable storage medium, wherein computer programs are stored on the computer-readable storage medium, the computer programs, when executed by a processor, implement the method of claim 1.

15. The method of claim 2, wherein an edit control is displayed on the playing interface, and the method further comprises:
displaying an editing interface matched with the editing control in response to a triggering on the editing control; and
editing a draft resource played on the playing interface in response to a triggering on the editing interface.

16. The method of claim 3, wherein an edit control is displayed on the playing interface, and the method further comprises:
displaying an editing interface matched with the editing control in response to a triggering on the editing control; and
editing a draft resource played on the playing interface in response to a triggering on the editing interface.

17. The method of claim 4, wherein an edit control is displayed on the playing interface, and the method further comprises:
displaying an editing interface matched with the editing control in response to a triggering on the editing control; and
editing a draft resource played on the playing interface in response to a triggering on the editing interface.

18. The method of claim 2, wherein a posting control is displayed on the playing interface, and the method further comprises:
in response to a triggering on the posting control, posting a draft resource played on the playing interface or switching to a video posting interface.

19. The method of claim 3, wherein a posting control is displayed on the playing interface, and the method further comprises:
in response to a triggering on the posting control, posting a draft resource played on the playing interface or switching to a video posting interface.

20. The method of claim 4, wherein a posting control is displayed on the playing interface, and the method further comprises:
in response to a triggering on the posting control, posting a draft resource played on the playing interface or switching to a video posting interface.
